(19) United States
(12) Patent Application Publication
(10) Pub. No.: US 2017/0053405 A1
(43) Pub. Date: Feb. 23, 2017

(54) METHOD AND SYSTEM FOR CALIBRATION OF A MEDICAL IMAGING SYSTEM

(71) Applicant: Samsung Electronics Co., Ltd., Suwon-si (KR)

(72) Inventors: Nikunj Hemant DESAI, Bangalore (IN); Aditya BHARDWAJ, Doodenakundi (IN); Gaurav SHARMA, Bangalore (IN)

(21) Appl. No.: 15/242,981

(22) Filed: Aug. 22, 2016

(30) Foreign Application Priority Data
Aug. 21, 2015 (IN) 4395/CHE/2015

(51) Int. Cl. G06T 7/00

(52) U.S. Cl. CPC G06T 7/0018; G06T 7/0044

(57) ABSTRACT

Methods and systems for calibrating a medical imaging system based on visual feedback are described. A method includes projecting one or more points of a target area (real world) of the medical imaging system as an overlay on the feedback frame, wherein the feedback frame is an image of the target area captured by an imaging device of a visual feedback system. One or more points of the target area are then located on the feedback frame. Further, the method includes improving calibration accuracy of the medical imaging system by minimizing difference between one or more projected points and one or more point located on the feedback frame below a predefined threshold. The difference is minimized via an iterative error correction mechanism.

### CROSS-REFERENCE TO RELATED APPLICATION(S)

This application claims the benefit under 35 U.S.C. §119(a) of an Indian Provisional application filed on Aug. 21, 2015 with the Indian Patent Office and assigned Serial No. 4395/CHE/2015, and under 35 U.S.C. §119(a) of an Indian patent application filed on Aug. 17, 2016 and assigned Serial No. 4395/CHE/2015, the disclosure of each of which is hereby incorporated herein in its entirety by reference.

### BACKGROUND

1. Field of the Invention

The various embodiments herein generally relate to the field of medical imaging systems, and more particularly, to calibration of medical imaging systems.

2. Description of the Related Art

Modern diagnostic medicine has benefited significantly from medical imaging systems that enable generating images of internal and/or external body structures of a subject under observation. To capture images of intended body parts of the subject, conventionally, a user of a medical imaging system is required to manually perform an initial acquisition setup or calibration based on inputs at a target area (patient acquisition area) determined based on manual observation.

Efforts to provide a higher level of automation for calibration of medical imaging systems are important. Automation for image acquisition setup reduces time consumed for initial setup, time consumed per subject (patient) and effectively increases patient throughput. The automation may be brought in by an imaging device assisted medical imaging system that may provide the user, such as a field engineer or physician, with visual feedback (still image or video) of the acquisition setup with reference to the patient acquisition area of interest for calibrating the medical imaging system. However, existing systems providing visual feedback are independent systems without any integration or direct coupling with the medical imaging system to be calibrated.

### OBJECT OF INVENTION

The principal object of the example embodiments herein is to provide methods and systems for calibrating a medical imaging system based on visual feedback by capturing an image of a target are of the medical imaging system, determining, based on an image data set, frame coordinates of at least one point included in the target area, the frame coordinates indicating a location of the at least one point in a feedback frame, projecting the at least one point included in the target area as an overlay on the feedback frame based on mapping and the image data set, wherein the mapping includes converting real world coordinates of the at least one point included in the target area to the frame coordinates, and calibrating the medical imaging system, wherein the calibrating includes iterative error correction reducing a difference between coordinates of the projection of the at least one point and the frame coordinates of the at least one point to below a threshold.

Another object of the example embodiments herein is to provide methods and systems for improving calibration accuracy of the medical imaging system by reducing the difference between one or more located points and one or more corresponding projected points in the feedback frame to below a predefined threshold during the alignment, wherein the difference is minimized via an iterative error correction mechanism.

### SUMMARY

In view of the foregoing, an example embodiment herein provides a method of calibrating a medical imaging system based on visual feedback. The method comprises determining, based on an image data set, frame coordinates of at least one point included in the target area, the frame coordinates indicating a location of the at least one point in a feedback frame, projecting the at least one point included in the target area as an overlay on the feedback frame based on mapping and the image data set, wherein the mapping includes converting real world coordinates of the at least one point included in the target area to the frame coordinates, and calibrating the medical imaging system, wherein the calibrating includes iterative error correction reducing a difference between coordinates of the projection of the at least one point and the frame coordinates of the at least one point to below a threshold.

Example embodiments further disclose a visual feedback apparatus for calibrating a medical imaging system based on visual feedback. The visual feedback apparatus comprises an imaging device configured to capture an image of a target area of the medical image system, and a calibration module configured to determine, based on an image data set, frame coordinates of at least one point included in the target area, the frame coordinates indicating a location of the at least one point in a feedback frame, project the at least one point of the target area as an overlay on the feedback frame using a mapping mechanism and the image data set, wherein the mapping mechanism converts real world coordinates of the at least one point included in the target area to the frame coordinates and calibrate the medical imaging system, wherein the calibration includes iterative error correction reducing a difference between coordinates of the projection of the at least one point and the frame coordinates of the at least one point to below a predefined threshold.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF FIGURES

The example embodiments of this disclosure are illustrated in the accompanying drawings, throughout which like reference letters indicate corresponding parts in the various figures. The various embodiments herein will be better understood from the following description with reference to the drawings, in which:

FIG. 1 illustrates an example system comprising a medical imaging system assisted by a visual feedback system for calibration of the medical imaging system based on visual feedback, according to embodiments of the present disclosure;

FIG. 2 illustrates a plurality of components of the visual feedback system, according to embodiments of the present disclosure;

FIG. 3 is a flow diagram illustrating a method of visual feedback based calibration of the medical imaging system, according to embodiments of the present disclosure;

FIG. 4 is a flow diagram illustrating a method of projecting one or more points of a target area in the medical imaging system as an overlay on the feedback frame, which includes one or more images of the target area captured by an imaging device, according to embodiments of the present disclosure;

FIGS. 5A, 5B and 5C illustrate feedback frames used for calibration, according to embodiments of the present disclosure; and

FIG. 6 illustrates feedback frames with no estimated error correction and with estimated error correction, respectively, according to embodiments of the present disclosure.

### DETAILED DESCRIPTION

The various embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments of the present disclosure.

The example embodiments herein achieve methods and systems for calibrating a medical imaging system based on visual feedback. A method includes projecting one or more points of a target area (real world) in the medical imaging system as an overlay on the feedback frame. The feedback frame may include one or more images of the target area captured by an imaging device of a visual feedback system. One or more points of the target area are then located in the feedback frame. Further, the method includes calibrating accuracy of the medical imaging system by reducing the difference between one or more projected points (overlay) and one or more located points on the feedback frame to below a predefined threshold. The difference or the error in mapping of real world coordinates of the points to frame coordinates of the feedback frame is minimized via an iterative error correction mechanism.

In an example embodiment, the imaging device may be a camera installed as an independent element of the visual feedback system or may be integrated into the medical imaging system or may be any other imaging sensor capable of capturing target images and providing the same to the visual feedback system for the calibration.

In an example embodiment, the medical imaging system may be an X-ray imaging system, a Computed Tomography (CT) system, or any other medical imaging system.

Example embodiments of the present disclosure enable automation of medical imaging systems, for example, an X-ray imaging system, for image acquisition planning for diagnostics, thereby increasing patient throughput.

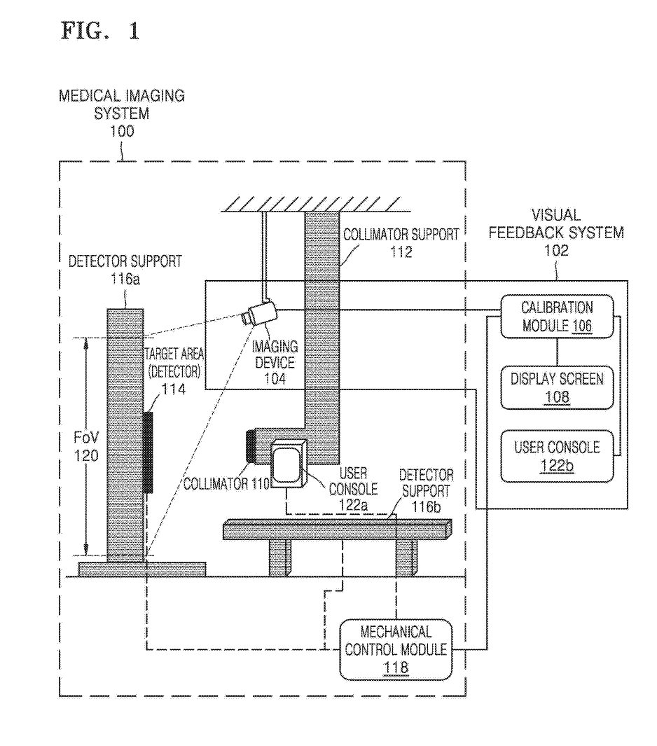

Referring now to the drawings, FIGS. 1 through 6, where similar reference characters denote corresponding features consistently throughout the figures, example embodiments are described.

FIG. 1 illustrates an example system comprising a medical imaging system 100 assisted by a visual feedback system 102 for calibration of the medical imaging system 100 based on visual feedback, according to embodiments of the present disclosure.

In the example herein, the medical imaging system 100 is an X-ray imaging system with a collimator end and a detector end. At the collimator end, a collimator 110 supported by a collimator support 112 directs emitted X-rays toward a subject, for example the patient, present at a target area 114 (detector). The target area 114 may be located, for example, on the detector support 116a or the detector support 116b. A user console 122a, at the collimator end, may provide a User Interface (UI) for the user (for example, a field engineer, physician, or the like) with a plurality of controls for capturing images of a subject using the medical imaging system 100.

In the example embodiments herein, the visual feedback system 102 may automate image acquisition setup or calibration of the medical imaging system 100, thereby assisting the medical imaging system 100. The visual feedback system 102 may include a calibration module 106 an imaging device 104, a user console 122b, and a display screen 108. The calibration module 106, in combination with the imaging device 104, the user console 122b, and the display screen 108, may calibrate the medical imaging system 100 for image acquisition setup. The user console 122b may provide a User Interface (UI) for the user (for example, field engineer, physician, or the like) during calibration of the medical imaging system 100.

To calibrate the medical imaging system 100 with assistance from the visual feedback system 102, the calibration module 106 may generate an image data set of the target area 114, wherein the target area 114 lies within the field of vision (FoV) 120 of the imaging device 104. The image data set may be generated by capturing a plurality of images of the target area 114 while a pre-defined pattern is included in the target area 114. The pre-defined pattern may be, for example, a checkerboard pattern, but is not limited thereto. The position of the target area 114 and the distance between the target area 114 and the imaging device 104 may be varied for each captured image. Further, generating the image data set may include identifying a plurality of reference points on the pre-defined pattern. Thereafter, corresponding metadata associated with the reference points, such as real world coordinates or 3D coordinates of the reference points, frame coordinates (e.g., coordinates of the reference points as projected on a frame, for example, a feedback frame), and the like, is determined and stored. The image data set and the metadata may be made available for further analysis for calibration of the medical imaging system 100. A mechanical control module 118 may also control positioning of the collimator support, positioning of the target area 114 on the detector support 116a or the detector support 116b, and positioning of the user console 122b. The real world coordinates of the reference points may be obtained from the mechanical control module 118 of the medical imaging system 100.

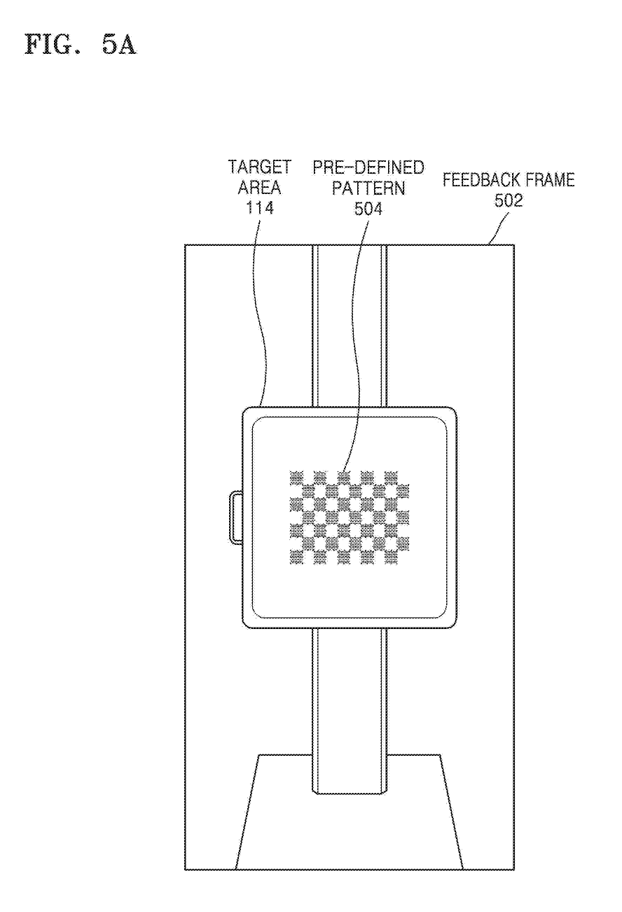

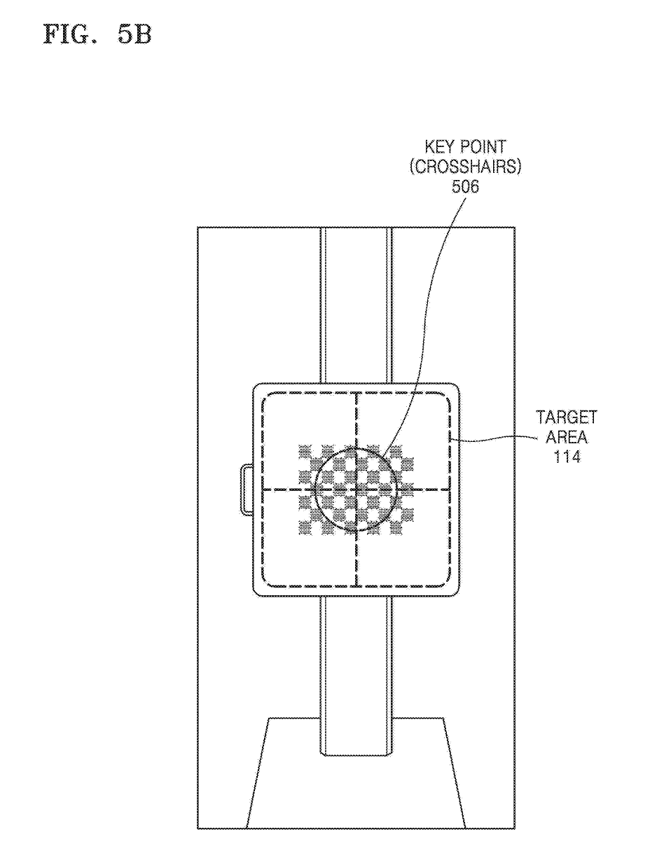

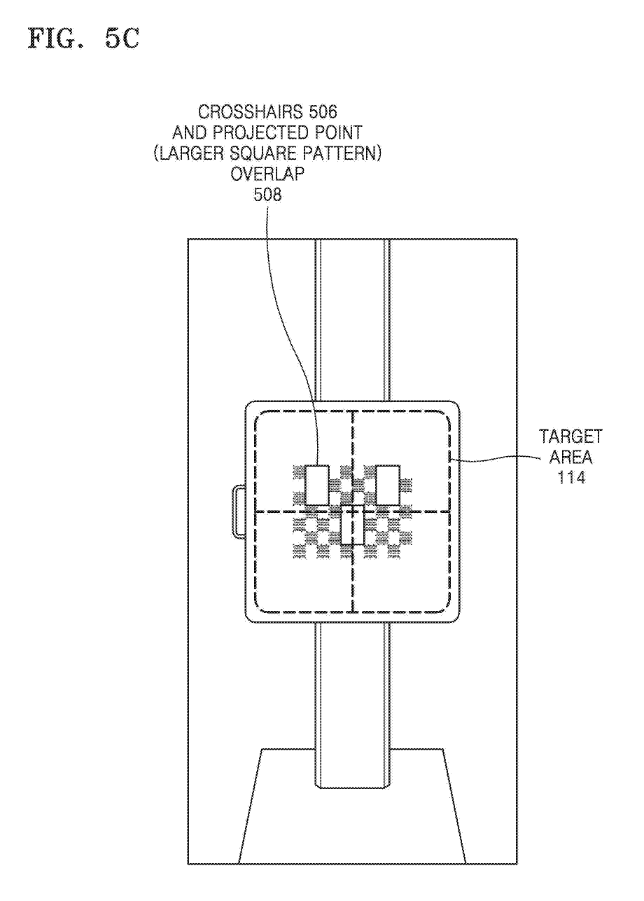

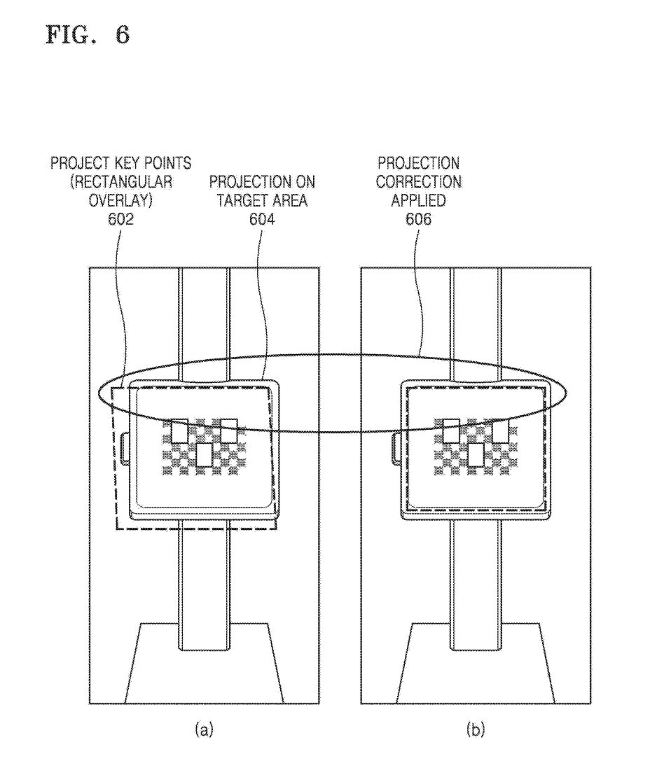

Once the image data set is generated, the calibration module 106 may again capture one or more images of the target area 114. A feedback frame including one or more captured images of the target area 114 may be displayed on the display screen 108 and be viewable by the user. The feedback frame may include, for example, one or more captured still images, video images, or a combination thereof. The user may locate one or more points of the target area 114 (real world) based on the feedback frame. The image data set may be used to identify coordinates of one or more of the points (located points) included in the target area 114. For example, in the example of FIG. 5B, crosshairs may indicate the location or coordinates of a point for the X-ray imaging system. In another example, referring to FIG. 6, the calibration module 106 may cause the display screen 108 to display corner points of a target area as points projected as an overlay on the feedback frame.

Once the frame coordinates of one or more points are identified (e.g., once points included in the feedback frame and corresponding to the points of the target area are identified), the calibration module 106 may display (i.e., control to project), via the display screen 108, the corresponding points as an overlay on the visual feedback frame, using a mapping mechanism and the image data set.

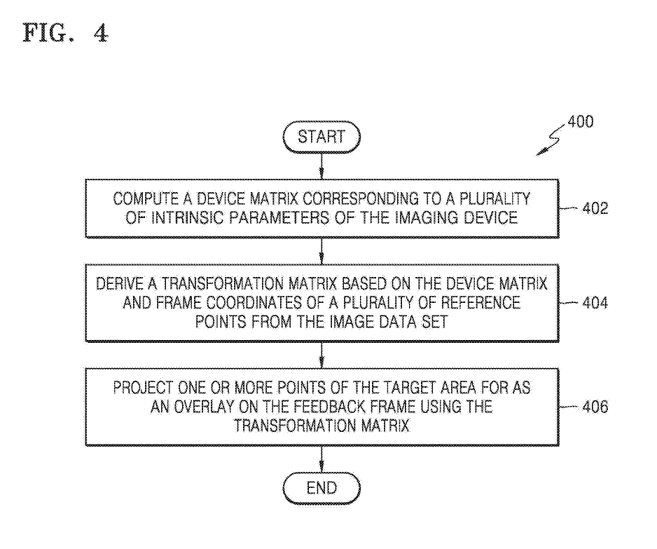

The mapping mechanism, explained in conjunction with FIG. 4, may convert real world 3D coordinates of one or more points of the target area 114 (i.e., located points) to coordinates in the feedback frame (e.g., example, 2D coordinates) displayed on the display screen 108 (i.e., projected points). For example, the mapping mechanism may convert real world 3D coordinates of points in the target area 114 (i.e., located points) to corresponding 2D coordinates of points displayed in the feedback frame (i.e., projected points). Further, the calibration module 106 may calibrate the medical imaging system 102 based on overlap and alignment between the located points and the projected points. Maximum overlap between the located points and the projected points provides maximum calibration accuracy, which may be obtained by minimizing the difference (e.g., minimizing error) between one or more located points and one or more corresponding projected points. The minimization may be carried out using the iterative error correction mechanism so as to reduce the error in mapping the real world 3D coordinates of the points (i.e., located points) to the frame coordinates of the points within the frame (i.e., projected points, or the corresponding 2D coordinates of locations as displayed in the feedback frame). The iterative error correction mechanism minimizes difference between one or more located points and one or more corresponding projected points in the feedback frame by estimating parameters of an error function. The error function may be a function of the position of the imaging device and the position of at least one projected point. Once the error is reduced below a predefined threshold, the desired accuracy may be said to have been achieved. The user may observe whether the calibration is achieved based on the proximity between the located points and the projected points within the feedback frame.

Once calibration of the medical imaging system 102 is completed by the calibration module 106, the medical imaging system 102 may generate more accurate measurements of a distance between a source and an object (for example, distance between a patient and the collimator), hence providing for automation in adjusting radiation doses delivered to the patient. Further, the calibrated imaging system 102 may provide fine adjustments to an imaging collimation area and thereby improve the accuracy of radiation doses delivered to the patient.

Example embodiments herein enable the projection of planes corresponding to the patient, detector and collimator planes onto the plane of the media (e.g., the target area 114). A camera may serve as an interface to the medical imaging system. Example embodiments herein may be used for calibrating the camera for adjusting a collimation region. Example embodiments herein may be used for calibrating the camera and for determining a stitching range and the number of images to be captured for generating a feedback frame for calibration.

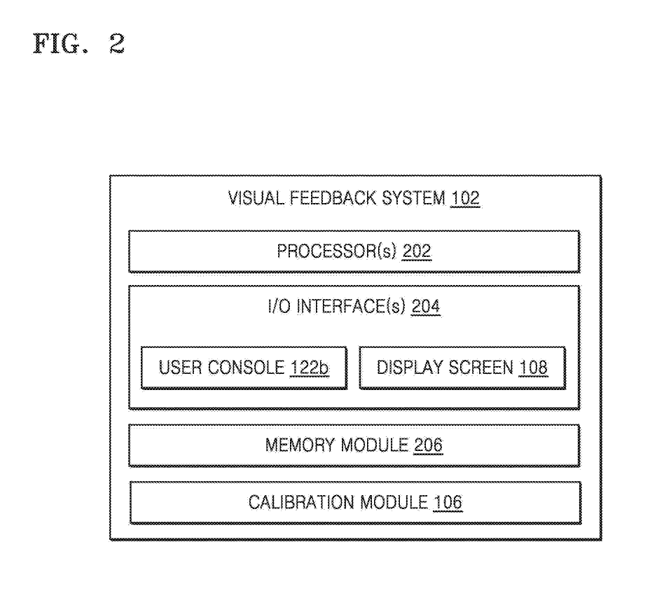

FIG. 2 illustrates a plurality of components of the visual feedback system 102, according to embodiments of the present disclosure.

Referring to FIG. 2, the visual feedback system device 102 is illustrated in accordance with an example embodiment of the present disclosure. In an example embodiment, the visual feedback system 102 may include a processor 202, an input/output (I/O) interface 204, and a memory module 206. The I/O interface 204 may be a configurable interface and may include, for example, a web interface, a graphical user interface such as the display screen 108, the user console 122b, and the like. The visual feedback system 102 may communicate with other systems and devices over a wired network, Wi-Fi networks, device-to-device communication, and so on. For example, the visual feedback system 102 may communicate with other systems and devices, such as the mechanical control module 118 of the medical imaging system 100, via I/O interface 204. The memory module 206 may store the image data set. Further, the visual feedback system 102 comprises a calibration module 106 configured to perform steps as described in FIG. 1, and for the sake of brevity, description thereof will not repeated.

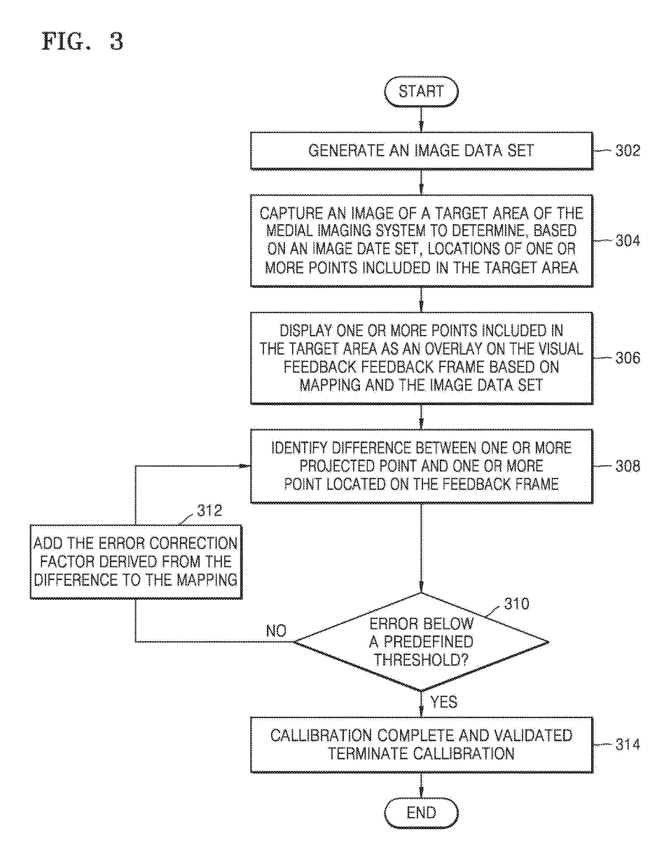

FIG. 3 is a flow diagram illustrating a method of calibrating the medical imaging system 100 based on visual feedback, according to embodiments of the present disclosure.

To calibrate the medical imaging system 100 assisted by the visual feedback system 102, the calibration module 106 may, at step 302 of the method 300, generate an image data set based on the Field of Vision (FoV) 120 of the imaging device 104. For example, the calibration module 106 may generate an image data set of the target area 114 lying within the Field of Vision (FoV) 120 of the imaging device 104. The image data set may be generated by capturing a plurality of images of the target area 114 while the pre-defined target pattern is included in the target area. The position of the target area 114 and distance between the target area 114 and the imaging device 104 may be varied, for example, for each captured image. Further, generating the image data set may include identifying a plurality of reference points on the pre-defined pattern. Thereafter, corresponding metadata associated with the reference points, such as real world coordinates or 3D coordinates of the reference points, frame coordinates (e.g., coordinates of the points as projected on a frame, for example, a feedback frame), and the like, is determined and stored. The image data set and the metadata may be made available for further analysis for calibration of the medical imaging system 100. The real world coordinates of the reference points may be obtained from the mechanical control module 118 of the medical imaging system 100.

Once the image data set is generated, the calibration module 106 may, at step 304 of the method 300, capture one or more images of the target area 114 to determine locations of one or more points included in the target area 114 (i.e., located points). The image data set may be used to identify coordinates (real world, 3D coordinates) of one or more of the points (i.e., located points) included in the target area 114, and further, to determine frame coordinates in the feedback frame (e.g., 2D coordinates) which correspond to the identified coordinates of the one or more points located in the target area 114 (i.e., located points). For example, crosshairs displayed in the feedback frame may be used to indicate a point located in the target area 114 (i.e., located point).

Once the frame coordinates of one or more points are identified (e.g., once points included in the feedback frame and corresponding to the points of the target area are identified and/or once points indicating coordinates in a feedback frame for the points of the target area are identified), the calibration module 106 may, at step 306 of the method 300, display (e.g., project), via the display screen 108, the corresponding points as an overlay on the visual feedback frame, using a mapping mechanism and the image data set. The mapping mechanism, explained in conjunction with FIG. 4, converts real world coordinates of one or more points of the target area 114 to coordinates on the feedback frame displayed on the display screen 108. The mapping mechanism is explained in conjunction with FIG. 4.

Further, at steps 308, 310 and 312 of the method 300, the calibration module 106 may calibrate the medical imaging system 102 by applying the iterative error correction mechanism described above that reduces or eliminates an identified difference between one or more located points and one or more corresponding projected points. The minimization using the iterative error correction mechanism may reduce or eliminate the error in the mapping mechanism during mapping of real world 3D coordinates to frame coordinates for calibration. The iterative error correction mechanism may reduce or eliminate the identified difference between the one or more located points and the one or more corresponding projected points by estimating parameters of the error function, and further, by adding an error correction factor. The error function may be a function of position of the imaging device and position of one or more of the projected points. The calibration module 106 may terminate calibration when the error function falls below the predefined threshold, thereby providing calibration accuracy. Once the error function falls below the predefined threshold, the calibration module 106 may, at step 314 of the method 300, terminate the calibration and confirm completion and validation of calibration of the medical imaging system 100.

The various actions in method 300 may be performed in the order presented, in a different order, or simultaneously. Further, in some example embodiments, some actions listed in FIG. 3 may be omitted.

FIG. 4 is a flow diagram illustrating a method 400 of projecting one or more points of the target area 114 in the medical imaging system 102 as an overlay on the feedback frame, which includes one or more images of the target area 114 as captured by the imaging device 104, according to an embodiment of the present disclosure. At step 402 of the method 400, the calibration module 106 may compute a device matrix corresponding to a plurality of intrinsic parameters of the imaging device 104. At step 404 of the method 400, the calibration module 106 may derive, from the image data set, a transformation matrix based on the device matrix and frame coordinates of the plurality of reference points. At step 406 of the method 400, the calibration module 106 may project one or more points of the target area for as an overlay on the feedback frame, which includes one or more images of the target area, using the transformation matrix. The various actions in method 400 may be performed in the order presented, in a different order, or simultaneously. Further, in some example embodiments, some actions listed in FIG. 4 may be omitted.

FIGS. 5A, 5B and 5C illustrate a feedback frame used during calibration, according to embodiments of the present disclosure. FIG. 5A depicts a (visual) feedback frame 502 depicting target area 114 included in the FoV 120 of the imaging device 104. The feedback frame 502 may be generated based on one or more images of the target area 114 captured by the imaging device 104. The feedback frame 502 may include one or more still images or video images captured by the imaging device 104. In the feedback frame 502, the captured target area 114 is depicted with a pre-defined pattern 504 for generating the image data set. A point 506 (indicated by crosshairs) of the target area 114 is depicted in FIG. 5B, and upon calibration, crosshairs 506 and a point 508 (overlay using mapping mechanism) projected as on overlay on the feedback frame are seen overlapping each other, indicating completion of calibration in FIG. 5C.

Referring to FIG. 6, (a) illustrates a feedback frame in which no estimated error correction has been applied, and (b) illustrates a feedback frame in which estimated error correction has been applied, according to an embodiment of the present disclosure. In FIG. 6, (a) illustrates a feedback frame displayed on a display screen. The feedback frame may include one or more still images or video images. In the feedback frame, a projection 604 on the target area and a corresponding rectangular overlay 602 are depicted for aligning the medical imaging system 100 and the target area. For example, the feedback frame may include the captured image of the target area, the projection 604, and a corresponding rectangular overlay 602. In FIG. 6, (b) illustrates the feedback frame after projection correction 606 is applied. That is, in (b) of FIG. 6, the medical imaging system 100 and/or the target area (or a detector support on which the target area is located) have been repositioned such that the error between the projection 604 and the overlay 602 is reduced.

The example embodiments disclosed herein may be implemented through at least one software program running on at least one hardware device and performing network management functions to control the network elements. The network elements shown in FIG. 1 through FIG. 6 include blocks which may be at least one of a hardware device or a combination of a hardware device and a software module.

The foregoing description of the specific example embodiments will so fully reveal the general nature of the example embodiments herein that others can, by applying current knowledge, readily modify and/or adapt for various applications such specific example embodiments without departing from the generic concept, and, therefore, such adaptations and modifications should and are intended to be comprehended within the meaning and range of equivalents of the disclosed example embodiments. It is to be understood that the phraseology or terminology employed herein is for the purpose of description and not of limitation. Therefore, while the example embodiments herein have been described in terms of preferred example embodiments, those skilled in the art will recognize that the example embodiments herein may be practiced with modification within the spirit and scope of the example embodiments as described herein.

1. A method of calibrating a medical imaging system, the method comprising:
capturing, by an imaging device, an image of a target area of the medical imaging system;
determining, based on an image data set, frame coordinates of at least one point included in the target area, the frame coordinates indicating a location of the at least one point in a feedback frame;
projecting the at least one point included in the target area as an overlay on the feedback frame based on mapping and the image data set, wherein the mapping includes converting real world coordinates of the at least one point included in the target area to the frame coordinates; and
calibrating the medical imaging system, wherein the calibrating includes iterative error correction reducing a difference between coordinates of the projection of the at least one point and the frame coordinates of the at least one point to below a threshold.

2. The method as claimed in claim 1, wherein the image data set is generated by:
capturing a plurality of images of the target area while a pattern is included in the target area, wherein a position of the target area and a distance between the target area and the imaging device is varied for each captured image;
identifying a plurality of reference points included in the target area and determining corresponding frame coordinates in the feedback frame for the plurality of reference points, wherein the determining of the frame coordinates for the plurality of reference points is based on real world coordinates of the plurality of reference points that are received from a mechanical control module of the medical imaging system; and
storing the plurality of images along with metadata and the frame coordinates of the plurality of reference points included in the target area.

3. The method as claimed in claim 1, wherein the mapping comprises:
computing a device matrix corresponding to a plurality of intrinsic parameters of the imaging device; and
deriving, from the image data set, a transformation matrix based on the device matrix and frame coordinates of a plurality of reference points; and
projecting the at least one point included in the target area as the overlay on the feedback frame using the transformation matrix.

4. The method as in claim 1, wherein the iterative error correction includes estimating parameters of an error function and reducing the difference between the coordinates of the projection of the at least one point and the frame coordinates of the at least one point based on the estimated parameters, wherein the error function is a function of position of the imaging device and position of the projection of the at least one point.

5. A visual feedback apparatus for calibrating a medical imaging system, the apparatus comprising:
an imaging device configured to capture an image of a target area of the medical image system; and
a calibration module configured to
determine, based on an image data set, frame coordinates of at least one point included in the target area, the frame coordinates indicating a location of the at least one point in a feedback frame;
project the at least one point of the target area as an overlay on the feedback frame using a mapping mechanism and the image data set, wherein the mapping mechanism converts real world coordinates of the at least one point included in the target area to the frame coordinates; and
calibrate the medical imaging system, wherein the calibration includes iterative error correction reducing a difference between coordinates of the projection of the at least one point and the frame coordinates of the at least one point to below a predefined threshold.

6. The visual feedback apparatus as claimed in claim 5, wherein the imaging device is further configured to capture a plurality of images of the target area while a pattern is included in the target area, and
wherein the calibration module is further configured to generate the image data set with the plurality of images of the target area, wherein a position of the target area and a distance between the target area and the imaging device is varied for each captured image by:
identifying a plurality of reference points included in the target area and determining corresponding frame coordinates in the feedback frame for the plurality of reference points, wherein the determining of the frame coordinates for the plurality of reference points is based on real world coordinates of the plurality of reference points that are received from a mechanical control module of the medical imaging system; and
storing the plurality of images along with metadata and the frame coordinates of the plurality of reference points included in the target area.

7. The visual feedback apparatus as claimed in claim 5, wherein in projecting the at least one point included in the target area as the overlay on the feedback frame using the mapping mechanism, the calibration module is configured to:
compute a device matrix corresponding to a plurality of intrinsic parameters of the imaging device; and
derive, from the image data set, a transformation matrix based on the device matrix and frame coordinates of a plurality of reference points; and
project the at least one point of the target area as the overlay on the feedback frame using the transformation matrix.

8. The visual feedback apparatus as claimed in claim 5, wherein the iterative error correction includes estimating parameters of an error function and reducing the difference between the coordinates of the projection of the at least one point and the frame coordinates of the at least one point based on the estimated parameters, wherein the error function is a function of position of the imaging device and position of the projection of the at least one point.

9. A non-transitory computer-readable medium storing instructions thereon that, when executed, cause at least one processor to perform a method of calibrating a medical imaging system, the method comprising:
capturing, by an imaging device, an image of a target area of the medical imaging system;
determining, based on an image data set, frame coordinates of at least one point included in the target area, the frame coordinates indicating a location of the at least one point in a feedback frame;
projecting the at least one point included in the target area as an overlay on the feedback frame based on mapping and the image data set, wherein the mapping includes converting real world coordinates of the at least one point included in the target area to the frame coordinates; and
calibrating the medical imaging system, wherein the calibrating includes iterative error correction reducing a difference between coordinates of the projection of the at least one point and the frame coordinates of the at least one point to below a threshold.
